(19) United States
(12) Patent Application Publication
(10) Pub. No.: US 2006/0259198 A1
(43) Pub. Date: Nov. 16, 2006

(54) Intelligent system for detection of process status, process fault and preventive maintenance

(75) Inventors: Jozef Brcka, Loundonville, NY (US); Deana Delp, Tempe, AZ (US); Michael Grapperhaus, Dracut, MA (US); Paul Moroz, Marblehead, MA (US)

Correspondence Address: PILLSBURY WINTHROP SHAW PITTMAN, LLP, P.O. BOX 10500, MCLEAN, VA, 22102, US

(73) Assignee: TOKYO ELECTRON LIMITED, Tokyo (JP)

(21) Appl. No.: 11/441,050

(22) Filed: May 26, 2006

Related U.S. Application Data
(63) Continuation of application No. PCT/US04/36499, filed on Nov. 3, 2004.
(60) Provisional application No. 60/524,846, filed on Nov. 26, 2003.

(51) Int. Cl. G05B 19/04

(52) U.S. Cl. 700/246

(57) ABSTRACT

Embodiments of an intelligent modeling method and system monitor and perform analysis of semiconductor processing equipment as well as predict future states of that equipment based on the analysis, predict failures of the semiconductor processing equipment and/or determine equipment maintenance schedules.

This is a Continuation application of International Patent Application No. PCT/US04/036499, filed on Nov. 3, 2004, which relies for priority on U.S. Provisional Patent Application No. 60/524,846, filed Nov. 26, 2003, the entire contents of both of which are incorporated herein by reference in their entireties.

### FIELD OF THE INVENTION

The present invention relates to control systems, particularly to a system in a semiconductor processing facility designed to monitor performance, predict failures and determine maintenance schedules.

### BACKGROUND OF THE INVENTION

Semiconductor processing techniques represent complex, non-linear physical environments wherein various process variables are under the control of an operator. Indeed, typically, an operator is in control of ten or more process variables that require constant monitoring. However, processing conditions can change over time, with small changes in critical process parameters creating undesirable results. These changes can easily occur in the composition or pressure of a processing gas, applied power, or wafer temperature resulting in the production of out of tolerance features on the semiconductor wafer.

Re-entrant wafer flows, critical processing steps and maintenance requirements in a semiconductor manufacturing plant contribute to a complex control task usually performed by one or more computers in a computerized control system. This control system handles multivariate data, the analysis and display of data and provides real-time process control.

### SUMMARY OF THE INVENTION

In accordance with at least one embodiment of the invention, an intelligent modeling method and system monitor and perform analysis of semiconductor processing equipment and predict future states of that equipment based on the analysis.

In accordance with at least one embodiment of the invention, an intelligent modeling method and system monitor and perform analysis in a semiconductor processing facility to predict failures and determine equipment maintenance schedules.

### BRIEF DESCRIPTION OF THE DRAWINGS

A more complete appreciation of the invention and much of the utility thereof will become readily apparent with reference to the following detailed description of several embodiments of the invention, particularly when considered in conjunction with the accompanying drawings, in which:

FIG. 1 illustrates a simplified block diagram of the reinforcement learning system designed in accordance with at least one embodiment of the present invention;

FIG. 2 illustrates a simplified block diagram of the non-linear intelligent system according to at least one embodiment of the present invention;

FIG. 3 illustrates a simplified diagram of a neural network; and

FIG. 4 illustrates a flowchart demonstrating a method of determining maintenance scheduling on a semiconductor process tool in accordance with at least one embodiment of the present invention.

### DETAILED DESCRIPTION OF SEVERAL EMBODIMENTS

Various embodiments of the present invention are directed to intelligent modeling methods and systems that monitor and perform analysis of semiconductor processing equipment as well as predict future states of that equipment based on the analysis, predict failures of the semiconductor processing equipment and/or determine equipment maintenance schedules.

Accordingly, the system model may obtain data indicating process measurements and known variables, for example, the time or times of last cleaning or maintenance or the time or times of last failures, to predict failure, next cleaning, and/or preventative maintenance schedules.

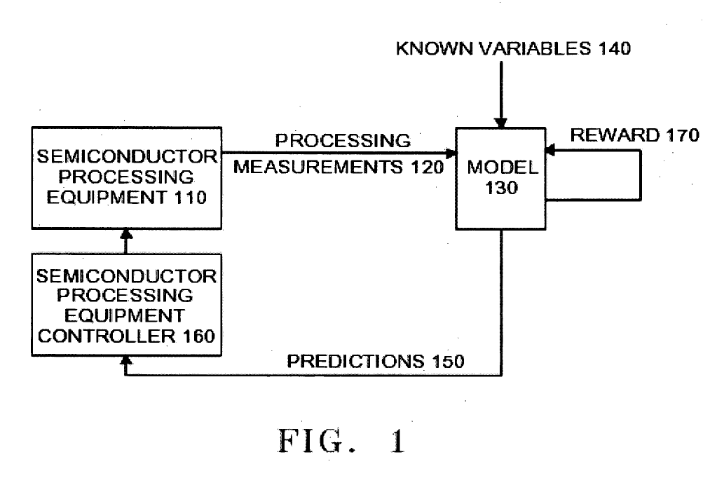

FIG. 1 illustrates a reinforcement learning system 100 whereby semiconductor processing equipment 110 outputs various process measurements 120, such as chamber temperature, gas mixture and applied Radio Frequency (RF) power, which are input into the model 130. Known variables 140, such as the time between a last equipment cleaning interval and time between last equipment failures, may also be entered into the model 130. This model 130 then simulates the future equipment states to determine the next time that equipment maintenance should be necessary based on the gathered data and other variables. The model 130 can then generate predictions 150, including predicted semiconductor processing equipment future states in near real-time and command or correction data, and transmit those predictions 150 to an equipment controller 160 coupled to or included in the equipment 110.

This model-based process control is a mathematical model of the relationship of parameters to results in a given semiconductor manufacture process. Models may be univariate or multivariate, linear or non-linear relationships, static or dynamic.

If the model is univariate, the univariate method may be designed to evaluate one variable at a time, although a second variable used to group or sort the variables may be implied.

If the model is multivariate, many independent and possible dependent variables may be analyzed. A large number of conventional software application programs can handle the complexity of large multivariate data sets. In a multivariate model, analysis of results is iterative and stochastic. For multivariate models, an appropriate data set may be composed of values related to a number of variables. Accordingly, appropriate data sets may be organized as a data matrix, a correlation matrix, a variance-covariance matrix, a sum-of-squares and cross-products matrix, or a sequence of residuals.

Static modeling may be performed after data collection for a wafer or lot has been completed; whereas, dynamic modeling may be performed in near real-time as data streams out of the manufacturing process. Models can be based on physical models of a process or on empirical results derived from observation of cause and effect within the process.

In accordance with at least one embodiment of the invention, the process measurements 120 may be used in an intelligent system, such as a neural network building a model to output data indicating a prediction of a next failure time and a preventative maintenance schedule as illustrated in FIG. 1.

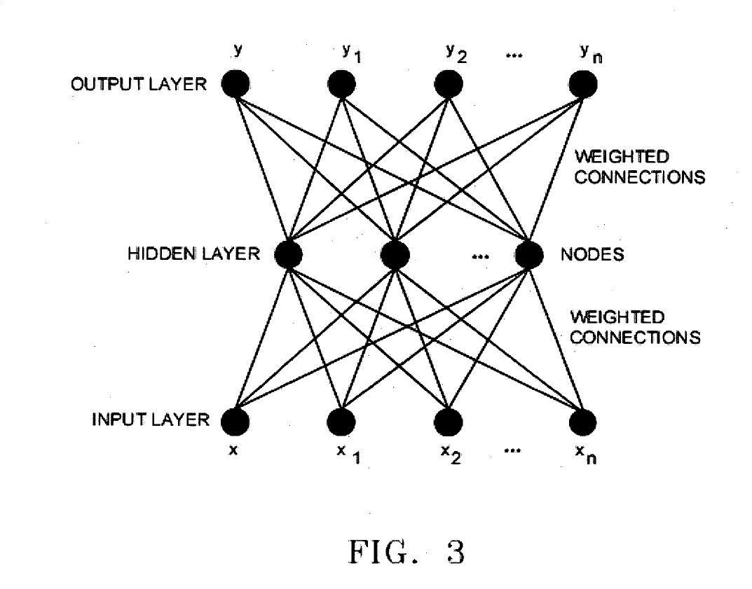

FIG. 3 is a simplified diagram of a neural network 300 that may be used to implement the non-linear model. As illustrated in FIG. 3, the neural network 300 includes n+1 input nodes, a variable number of hidden nodes, and n+1 output nodes.

It should be understood that neural networks store connected strengths (i.e., weight values) between the artificial neuron units. The weight value set comprising a set of values associated with each connection in the neural network, is used to map an input pattern to an output pattern. The set of weight values used between unit connections in a neural network is the knowledge structure. Learning here is defined as any self-directed change in a knowledge structure that improves performance. “Learning” in a neural network means modifying the weight values associated with the interconnecting paths of the network so that an input pattern maps to a pre-determined or “desired” output pattern.

In the study of neural network behavior, learning models have evolved that consist of rules and procedures to adjust the synaptic weights assigned to each input in response to a set of “learning” or “teaching” inputs. Most neural network systems provide learning procedures that modify only the weights—there are generally no rules to modify the activation function or to change the connections between units. Thus, if an artificial neural network has any ability to alter its response to an input stimulus (i.e., “learn”, as it has been defined), it can only do so by altering its set of “synaptic” weights.

In accordance with at least one embodiment of the invention, a group of learning techniques classified as pattern association, is used. The goal of pattern association systems is to create a map between an input pattern defined over one subset of the units (i.e., the input layer) and an output pattern as it is defined over a second set of units (i.e., the output layer). This process attempts to specify a set of connection weights so that whenever a particular input pattern reappears on the first set (input layer), the associated output pattern will appear on the second set (output layer). Generally in pattern association systems, there is a “teaching” or “learning” phase of operation during which an input pattern called a “teaching pattern” is input to the neural network. The teaching pattern comprises of a set of known inputs and has associated with it a set of known or “desired” outputs. If, during a teaching phase, the actual output pattern does not match the desired output pattern, a learning rule is invoked by the neural network system to adjust the weight value associated with each connection of the network so that the training input pattern will map to the desired output pattern.

Virtually all of the currently used learning procedures for weight adjustment have been derived from the learning rule of psychoanalyst D. O. Hebb, which states that if a unit, uⱼ, receives an input from another unit, uᵢ, and both are highly active, the weight, wⱼᵢ, in the connection from uᵢ to uⱼ should be strengthened.

The Hebbian learning rule has been translated into a mathematical formula:
wⱼᵢ=g(aⱼ (t), tⱼ (t)) h(oᵢ (t), wⱼᵢ) (1)

The equation states that the change in the weight connection wⱼᵢ from unit uᵢ to uⱼ is the product of two functions: g( ), with arguments comprising the activation function of uⱼ, aⱼ (t), and the teaching input to unit uⱼ, tⱼ (t), multiplied by the result of another function, h( ), whose arguments comprise the output of uᵢ from the training example, oᵢ (t), and the weight associated with the connection between unit uᵢ and uⱼ, wⱼᵢ.

This general statement of the Hebbian learning rule is implemented differently in different kinds of neural network systems, depending on the type of neural network architecture and the different variations of the Hebbian learning rule chosen. In one common variation of the rule, it has been observed that:
h(oᵢ (t), wⱼᵢ)=iᵢ (2)
and
g(aⱼ (t), tⱼ (t))=H(tⱼ (t)−aⱼ (t)) (3)

where iᵢ equals the ith element of the output of unit uᵢ (or the input to uⱼ), and H represents a constant of proportionality. Thus, for any input pattern p the rule can be written:
ₚwⱼᵢ=H(tₚⱼ−oₚⱼ)iₚᵢ=H Δₚⱼ iₚᵢ (4)

where tₚⱼ is the desired output (i.e., the teaching pattern) for the jth element of the output pattern for p, oₚⱼ is the jth element of the actual output pattern produced by the input pattern p, iₚᵢ is the value of the ith element of the input pattern. Δₚⱼ is the “delta” value and is equivalent to tₚⱼ−oₚⱼ; this difference represents the desired output pattern value for the jth output unit minus the actual output value for the jth component of the output pattern. ₚwⱼᵢ is the change to be made to the weight of the connection between the ith and jth unit following the presentation of pattern p.

Thus, returning to the detailed description of FIG. 1, if the system is designed to learn from previous operations, within the equipment controller 160 or elsewhere within the system, predicted values may be compared with actual values that correspond to the predicted values and assigned a reward value 170 for learning by model 130.

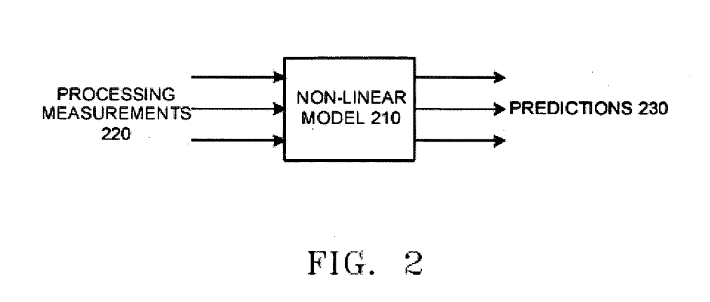

As illustrated in FIG. 2, in accordance with at least one embodiment of the invention, the intelligent system 200 may use a non-linear model 210 to predict maintenance schedules from processing measurements as illustrated in FIG. 2. The non-linear model 210 may be implemented, for example, as a neural network in a reinforcement learning setting. Regardless of its implementation, the non-linear model 210 may be implemented to receive inputs 220 including a reward value, time(s) of the last equipment maintenance/failure, and a combination of various processing measurements. The non-linear model 210 may also be configured to produce outputs 230 including suggested maintenance schedules for semiconductor processing equipment, e.g., a semiconductor fabrication chamber. Thus, the non-linear model 210 may predict a time for a next failure to occur and/or when next maintenance will be required for the equipment.

During configuration of the non-linear model as a tool used in conjunction with the semiconductor processing equipment, the model may be configured using offline simulations to completely model the semiconductor processing equipment, e.g., a chamber. The model may then be tested for reliability and validated. The reliability testing and validation may be performed by comparing previously predicted states with ongoing results. Accordingly, reward values may be implemented for continued learning and improved future predictions. For example, when a predicted state matches an actual state, a reward value of zero may be assigned, whereas an incorrect prediction may trigger assignment of a reward value of one.

The model may also be run offline to formulate maintenance schedules, perform additional data analysis, and analyze effects of changes to the semiconductor processing system. For example, the model may be used offline to run simulations for days and weeks in advance to formulate service maintenance schedules. In such a configuration, a data mining approach may be used to match the collected data regarding operation of the equipment with a need to perform maintenance and/or failure times.

For example, in such an approach, equipment operating parameters may be analyzed using some procedure, such as Principle Components Analysis (PCA), for finding relevant variables (components). This procedure may be used to analyze, for example, data collected during calibration and/or operation of the semiconductor processing equipment.

Fortunately, in data sets with many variables, groups of variables often move together. One reason for this is that more than one variable may be measuring the same driving principle governing the behavior of the system. In many systems, there are only a few such driving forces. PCA permits replacing a group of variables with a single new variable.

PCA is a quantitatively rigorous method for achieving this simplification. The method generates a new set of variables, called principal components. Each principal component is a linear combination of the original variables. Because all the principal components are orthogonal to each other, there is no redundant information. Thus, the principal components as a whole form an orthogonal basis for the space of the data.

PCA finds the eigenvalues and eigenvectors of a variance-covariance matrix or a correlation matrix. In accordance with at least one embodiment of the invention, a correlation matrix, e.g., using a normalized variance-covariance matrix, may be of particular utility because the collected data is in variables that are measured in different units; thus, some degree of normalizing of variables using division by their standard deviations may be necessary.

In PCA, the eigenvalues, giving a measure of the variance accounted for by the corresponding eigenvectors (components) are given for the first n most important components. The percentage of variance accounted for by the components determines the degree of success in modeling. For example, if most of the variance is accounted for by the first one or two components, the model may be considered successful; however, if the variance is spread more or less evenly among the components, the modeling may be considered less successful.

The non-linear model described hereto may be used in conjunction with, or include, an icon driven user interface as a front end that allows a user to interact with a user interface by clicking on an icon to retrieve data and take process measurements from the semiconductor processing equipment, e.g., chamber.

In accordance with the mapping of historical processing measurements and maintenance and failure times discussed above, for the non-linear model, multiple processing measurements from historical data may be collected for training and testing data. Collected data used by the model may include, for example, past processing measurements including CD (critical dimension measurement), gap (electrode spacing), He (backside He pressure), P (process pressure), Pₜ (remaining processing time), Q (total flow rate), % Q (flow rate ratio among gases), RF_{b} (bottom electrode RF power), RFₜ (top electrode RF power), T (chuck temperature), V_{PP} (peak to peak RF voltage), and/or V_{DC} (self-developed DC offset).

Corresponding maintenance and chamber failure times may be gathered from historical data to determine maintenance schedules. The processing measurements are used as inputs and the maintenance and/or failure times are used as outputs for training the neural network. For example, the non-linear model may have, for example, twelve input nodes (corresponding to CD, gap, He, P, Pₜ, Q, % Q, RF_{b}, RFₜ, T, V_{PP}, V_{DC}) and two output nodes, maintenance time and failure time.

Once the non-linear model satisfies error bounds for the training, testing data may be implemented to verify the model. This verification may involve comparison of past predicted equipment states with corresponding actual equipment states. The model may then be setup for continuous training with new data in the learning system.

In this continuous training, maintenance and failure times of the chamber are used to calculate a reward value. Thus, the reward value may be based on predicted maintenance times; as such the reward value may be as simple as the sum of the difference from the predicted maintenance/failure times to the actual maintenance/failure times. Thus, if the predicted times are close to the real maintenance/failure times, the reward value may be near 0. If the values differ the reward value may be large.

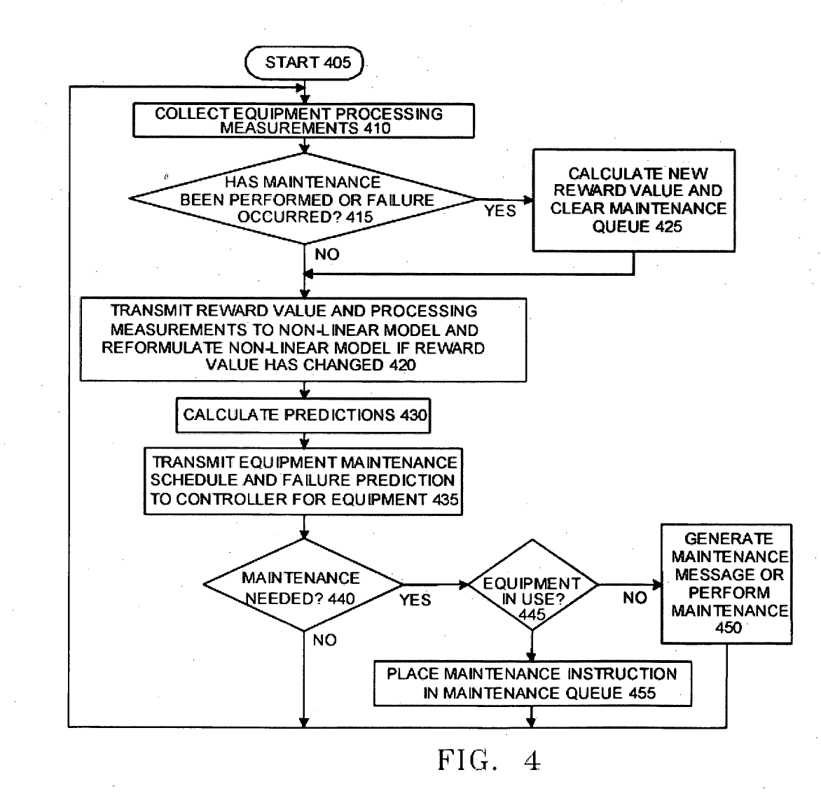

FIG. 4 is a flow diagram demonstrating operation of a learning system and neural network model designed in accordance with at least one embodiment of the invention. The operation begins at 405 and control proceeds to 410, at which equipment processing measurements are collected, e.g., chamber measurements such as CD, gap, He, P, Pₜ, Q, % Q, RF_{b}, RFₜ, T, T_{mf}, V_{PP}, V_{DC} and R. Control then proceeds to 415, at which a determination is made whether maintenance has been performed or a machine failure has occurred. If not, control proceeds to 420. If so, control proceeds to 425, at which a new reward value is calculated based on maintenance performed or the failure and any corresponding maintenance queue is cleared. Subsequently, control proceeds to 420.

At 420, the reward value and processing measurements are sent to the non-linear model, e.g., the neural network and the nonlinear model is reformulated if the reward value has been recalculated. Control then proceeds to 430, at which the predictions are calculated from the non-linear model; control then proceeds to 435 at which the maintenance schedule and failure prediction is sent to the controller controlling operation of the chamber. Control then proceeds to 440, at which a determination is made whether maintenance is needed based on the predictions from the non-linear model.

If maintenance is not needed, control returns to 410 for collection of additional processing measurements. If maintenance is needed, control proceeds to 445 at which a determination is made whether the chamber is busy. If so, control proceeds to 455, at which a maintenance request is placed in a maintenance queue. Control then returns to 410 for collection of additional processing measurements. If the chamber is not busy, control proceeds to 450 at which a prompt is issued to an operator to perform specified maintenance or the maintenance is performed automatically and control returns to 410 for collection of additional processing measurements.

This method of maintenance prediction can provide near real-time model based control and feedback of the chamber environment.

Although not illustrated, modeling of the equipment, maintenance schedule formulation and failure prediction may be performed after data collection for a wafer or lot has been completed. In such an embodiment, there need not be real-time re-modeling of the semiconductor fabrication equipment.

Moreover, the modeling may be more generally formulated for the model of semiconductor fabrication equipment rather than the particular piece of equipment. Thus, the model may be pre-formulated based on the type of equipment, e.g., a particular model number or production line of equipment, rather than on the particular piece of equipment itself.

Additionally, in accordance with at least one embodiment of the invention, the system may be pre-formulated based on the type of equipment but also be dynamically updated using the method illustrated in FIG. 4.

In accordance with at least one embodiment of the invention, the operator may override a system input with a value forcing a maintenance indication or a chamber fault indication. This overriding function may be used when an operator wishes to induce manual control of the maintenance of the semiconductor processing equipment or implement special processing or maintenance operations.

After initial development, the system model may make measurements of the equipment operating characteristics and predict current processing states and future states. The system model can determine current process status, maintenance schedules, data analysis, and effects of changes to the semiconductor fabrication equipment. The model can also simulate operations days/weeks in advance for determining service maintenance schedules.

Numerous modifications and variations of the present invention are possible in light of the above teachings. It is therefore to be understood that, within the scope of the appended claims, the invention may be practiced otherwise than as specifically described herein.

What is claimed is:

1. A method for determining a future state of semiconductor processing equipment, the method comprising:
training a neural network model with semiconductor processing equipment process measurements to predict failure of the semiconductor processing equipment.

2. The method of claim 1, further comprising updating the model by applying at least one reward value calculated based on past model accuracy in predicting failure of the semiconductor processing equipment.

3. The method of claim 1, further comprising formulating a maintenance schedule for the semiconductor processing equipment based at least in part on the model.

4. The method of claim 3, further comprising updating of the model by applying at least one reward value calculated based on past model accuracy in predicting maintenance requirements.

5. The method of claim 3, wherein the maintenance schedule is formulated using an input data set produced by Principle Component Analysis.

6. The method of claim 1, wherein semiconductor processing equipment processing measurements include at least one of a time of last cleaning of the semiconductor processing equipment, a time of last maintenance of the semiconductor processing equipment, a time of a last failure of the semiconductor equipment and a preventative maintenance schedule for the semiconductor processing equipment.

7. The method of claim 1, wherein the neural network outputs data including at least one of a suggested maintenance schedule for the semiconductor processing equipment, a suggested cleaning schedule for the semiconductor processing equipment and a predicted time for a next failure of the semiconductor processing equipment.

8. The method of claim 1, further comprising obtaining data indicating the semiconductor equipment process measurements used for predicting the failure of the semiconductor equipment.

9. The method of claim 1, wherein the processing measurements include at least one of chamber temperature, gas mixture and applied radio frequency power.

10. The method of claim 1, wherein the model is multivariate.

11. The method of claim 10, wherein the model analyzes data sets organized as, a data matrix, a correlation matrix, a variance-covariance matrix, a sum-of-squares, a cross-products matrix, or a sequence of residuals.

12. The method of claim 1, wherein the model is dynamic and the model is updated as processing measurement data is produced by the semiconductor processing equipment.

13. The method of claim 1, wherein the model is formulated using offline simulations to completely model the semiconductor processing equipment.

14. The method of claim 13, further comprising testing the model for reliability and validating the model by comparing previously predicted states with processing measurements produced by the semiconductor processing equipment.

15. The method of claim 1, further comprising providing an icon driven user interface as a front end that allows a user to retrieve data and obtain processing measurements from the semiconductor processing equipment.

16. A system for determining a future state of semiconductor processing equipment, the system comprising:
a neural network model trained with semiconductor processing equipment process measurements to predict failure of semiconductor processing equipment.

17. The system of claim 16, wherein the model is updatable by applying at least one reward value calculated based on past model accuracy in predicting failure of the semiconductor processing equipment.

18. The system of claim 16, wherein semiconductor processing equipment processing measurements include at least one of a time of last cleaning of the semiconductor processing equipment, a time of last maintenance of the semiconductor processing equipment, a time of a last failure of the semiconductor equipment and a preventative maintenance schedule for the semiconductor processing equipment.

19. The system of claim 16, wherein the model formulates a maintenance schedule for the semiconductor processing equipment based at least in part on the model.

20. The system of claim 19, wherein the model is updatable by applying at least one reward value calculated based on past model accuracy in predicting maintenance requirements.

21. The system of claim 19, wherein the maintenance schedule is formulated using an input data set produced by Principal Components Analysis.

22. The system of claim 19, the system further comprising a semiconductor processing equipment controller which receives data output from the neural network and including at least one of a suggested maintenance schedule for the semiconductor processing equipment, a suggested cleaning schedule for the semiconductor processing equipment and a predicted time for a next failure of the semiconductor processing equipment.

23. The system of claim 22, wherein the equipment controller uses the data output from the neural network in at least one servo control loop.

24. The system of claim 23, wherein the at least one servo control loop provides one of Proportional-integral, Proportional-Derivative, or Proportional-Integral-Derivative control, to maintain desired values of controlled variables for the semiconductor processing equipment.

25. The system of claim 16, wherein the model obtains data indicating the semiconductor equipment process measurements used for predicting the failure of the semiconductor equipment.

26. The system of claim 25, wherein the data obtained includes at least one of a time of last cleaning of the semiconductor processing equipment, a time of last maintenance of the semiconductor processing equipment, a time of a last failure of the semiconductor equipment and a preventative maintenance schedule for the semiconductor processing equipment.

27. The system of claim 16, wherein the processing measurements include at least one of chamber temperature, gas mixture or applied radio frequency power.

28. The system of claim 16, wherein the model is multivariate.

29. The system of claim 16, wherein the model is dynamic and the model is updated as processing measurement data is produced by the semiconductor processing equipment.

30. The system of claim 16, wherein the model is formulated using offline simulations to completely model the semiconductor processing equipment.

31. The system of claim 16, further comprising an icon driven user interface as a front end of the system that allows a user to retrieve data and take process measurements from the semiconductor processing equipment.

32. A method for determining a future state of semiconductor processing equipment, the method comprising:
predicting a maintenance schedule of the semiconductor processing equipment using a model determined from past performance based on semiconductor processing equipment processing measurements.

33. A system for determining a future state of semiconductor processing equipment, the system comprising:
a model determined from past performance of the semiconductor processing equipment and configured to output data indicating a maintenance schedule of the semiconductor processing equipment based on semiconductor processing equipment processing measurements.
